(19) United States
(12) Patent Application Publication
(10) Pub. No.: US 2004/0245513 A1
(43) Pub. Date: Dec. 9, 2004

(54) Handrail jointer

(76) Inventor: Shuhei Izumi, Toyoma-shi (JP)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/493,294

(22) PCT Filed: Oct. 19, 2001
(86) PCT No.: PCT/JP01/09177

(51) Int. Cl. E04H 17/00; F16B 7/18

(52) U.S. Cl. 256/65.02; 403/170

(57) ABSTRACT

A handrail jointer which is most suitable to install a handrail easily at a placing site even on a slope which is bent and has a complicated shape having a varying inclination. The handrail jointer 1 comprises the post connector 10 connected to the post 5, the handrail holders 31, 32 having the handrail holding portions 31a, 32a holding the handrail members 7, and the elbow body 20 attached to the post connector 10 and having the fitting portions 23, 24 for fitting the handrail holders 31, 32. These handrail holders 31, 32 are rotatably attached at certain angles to the fitting portions 23, 24 so that the handrail holders 31, 32 can rotate in a neck roll exercise manner on the fitting portions 23, 24.

### FIELD OF THE INVENTION

The present invention relates to a handrail jointer, more specifically a handrail jointer appropriate for setting handrails on a bent slope.

### DESCRIPTION OF THE PRIOR ART

Conventionally, when handrails are to be installed on the slope, the following steps are taken. First, by means of survey on a handrail placing site, the angle of gradient of the slope and the locations where the posts are to be installed are determined. Based on the findings of the survey and by such means as welding the handrail holders in accordance with the angle of gradient of the installation locations of the posts, support members are prepared. Once the support members are prepared, those support members along with handrail members are carried to the placing site, put together and installed at the site. For a comparatively easy case such that the installation locations are few, the angle of gradient is surveyed at the site, the connection angles are determined and the handrails and support members are put together at the site.

However, there exists a problem that it is cumbersome to prepare the right handrail material for the respective case depending on the angle of gradient of the placing site. Furthermore, when the slope where the handrails are to be installed are bent and/or its angle of gradient changes from place to place, it is cumbersome to prepare the right support material and takes a lot of trouble to install them. In this case, because the members suitable for the installation locations, which should be custom-made, have to be prepared, the total cost tends to be very high.

So far, there has not been any handrail jointer that can be assembled at the site easily and can adjust the connection angles of the handrails in accordance with the incline and bend of the placing site.

The present invention is to provide solutions for the above-mentioned problems and,therefore, the object of the invention is to provide handrail jointers that make the installation of handrails very easy on a slope where the handrails are to be installed even when the slope is bent and has a complicated shape with a varying inclination.

### DISCLOSURE OF INVENTION

To provide solutions for the above-mentioned problems, an invention in Claim 1 provides a handrail jointer comprising a post connector that connects with a post, handrail holders that have handrail holing portions to hold handrail members and an elbow body that connects to the post connector and has fitting portions to attach the rail holders, being characterized in that the handrail holders are rotatably attached to the fitting portions with certain angles, whereby the handrail holders can rotate in a neck roll exercise manner around the fitting portions.

To provide solutions for the above-mentioned problems, an invention in Claim 2 is characterized in that the fitting portions of the handrail jointers defined in Claim 1 are formed aslant to the elbow body.

To provide solutions for the above-mentioned problems, an invention in Claim 3 is characterized in that the elbow body of the handrail jointer defined in Claim 1 or Claim 2 is rotatably attached to the post connector.

To provide solutions for the above-mentioned problems, an invention in Claim 4 is characterized in that, while the elbow body of the handrail jointer defined in one of Claims 1˜3 has an approximate spherical shape by consisting of a first semisphere and a second semisphere, the opening planes of which are put together, being provided with said fitting portions in diagonally opposite locations on the surface thereof, the first semisphere and the second semisphere can relatively rotate on the same axis.

To provide solutions for the above-mentioned problems, an invention in Claim 5 is characterized in that the fitting portions of the handrail jointer defined in Claim 4 are formed aslant to the elbow body and directed at certain tilting angles in a vertical plane with respect to the opening planes of the first semisphere and the second semisphere.

To provide solutions for the above-mentioned problems, an invention in Claim 6 is characterized in that the tilting angle of the fitting portions of the handrail jointer mentioned in Claim 5 is from 5 degrees to 25 degrees.

To provide solutions for the above-mentioned problems, an invention in Claim 7 is characterized in that the axis of rotation of the first semisphere and the second semisphere of the handrail jointer mentioned in one of Claims 4˜6 is perpendicular or aslant to the center axis of the post connector.

To provide solutions for the above-mentioned problems, an invention in Claim 8 is characterized in that the first semisphere and the second semisphere of the handrail jointer mentioned in Claim 6 or Claim 7 are relatively rotatably attached to a connecting section formed on the post connector.

To provide solutions for the above-mentioned problems, an invention in Claim 9 is characterized that the tilting angle of the fitting portions formed on the elbow body of the handrail jointer defined in one of Claims 6˜8 is the same as the attaching angle of the handrail holder with respect to the fitting portions.

### BRIEF DESCRIPTION OF THE DRAWINGS

FIG. 1 is an exploded perspective view showing one embodiment of the handrail jointer of the present invention.

FIG. 2 is a vertical cross-sectional view showing the handrail jointer shown in FIG. 1.

FIG. 3 is a vertical cross-sectional view showing a different state from the one in FIG. 2.

FIG. 4 is a plane view showing the movement of the handrail holders.

FIG. 5 is a side view showing the first semisphere and the second semisphere.

FIG. 6 is a side view showing the handrail holder.

FIG. 7 is a front view showing the post connector.

FIG. 8 is a side view showing the handrail jointer in a different embodiment from the one in FIG. 1.

FIG. 9 is a side view showing another embodiment of the handrail jointer.

FIG. 10 is a side view showing the handrail holder with the connecting section.

FIG. 11 is a side view showing the handrail holder with the connecting section at a slant.

FIG. 12 is a plane view showing the handrail member being attached to the handrail holder by means of adhesive.

FIG. 13 is a plane view showing the handrail member being attached to the handrail holder by means of welding.

FIG. 14 is a plane view showing the handrail member being attached to the handrail holder by means of a turning screw and a fastening screw.

FIG. 15 is a plane view showing the handrail member being attached to the handrail holder by means of support portion.

FIG. 16 is a perspective view showing the slope where the handrails being installed on the slope by using the handrail jointers of the present invention.

FIG. 17 is an exploded perspective view showing the elbow body and the fitting portions of another embodiment.

### THE BEST MODE FOR CARRYING OUT THE INVENTION

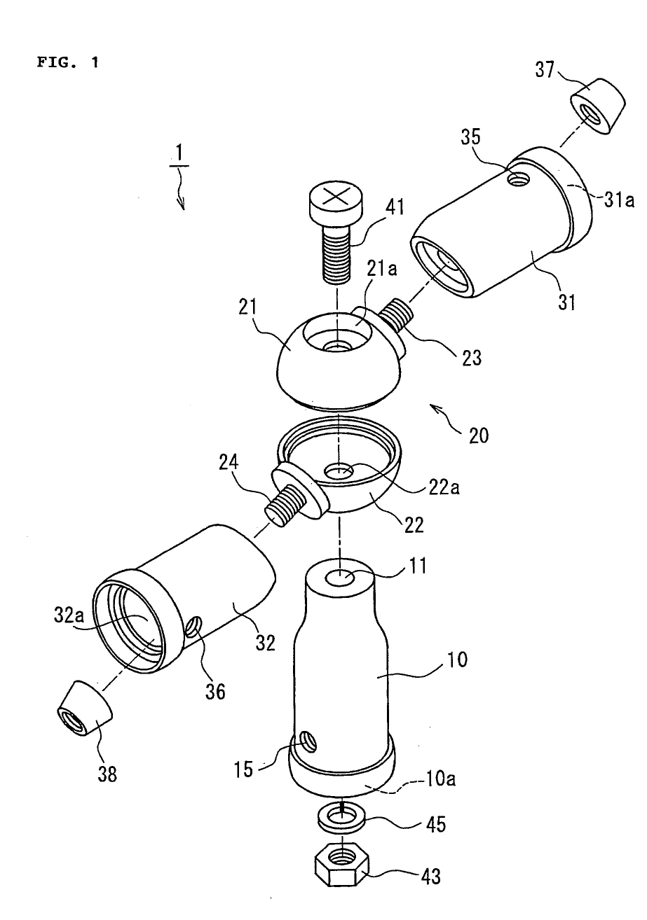

From now on, an embodiment of the handrail jointer according to the present invention will be explained by referring to the figures. FIG. 1 is an exploded perspective view showing an embodiment of the handrail jointer in accordance with the present invention.

The handrail jointer 1 shown in FIG. 1 has the post connector 10 with post connecting portion 10a that is connected with the post 5 that is installed on the slope 3 as shown in FIG. 16 which is bent and inclined, the elbow body 20 that has an approximate spherical shape consisting of the first semisphere 21 and the second semisphere 22, the opening planes of which are put togather, and handrail holders 31, 32 that have the handrail supporting parts 31a, 32a to support the handrail members 7.

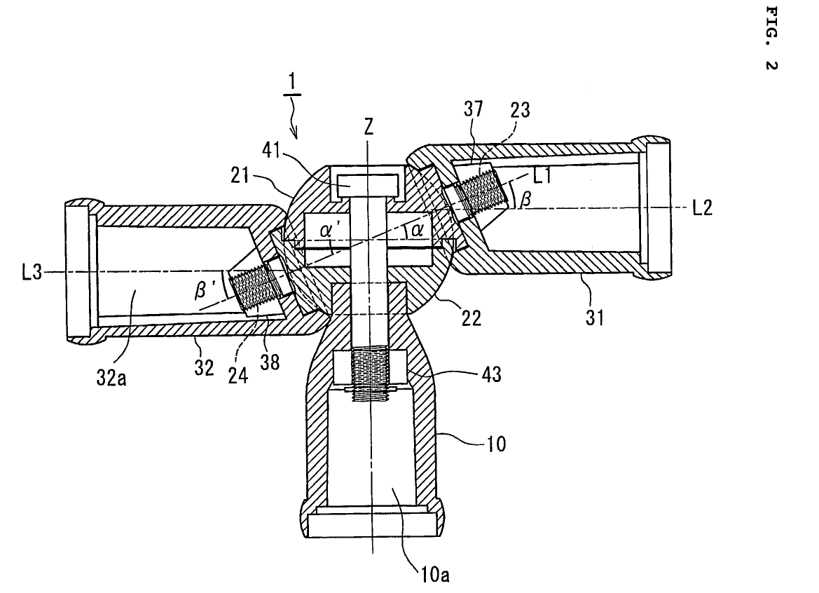

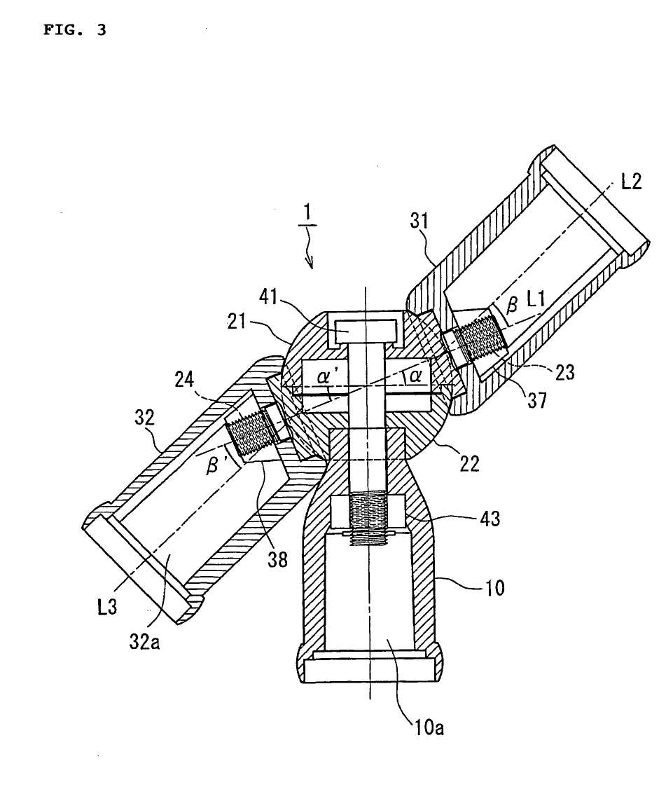

At the first semisphere 21 that forms the elbow body 20, as shown in FIG. 5, the bolt shaped fitting portion 23 having male-screw therearound is provided to attach the handrail holder 31. The fitting portion 23, as shown in FIGS. 2 and 3, is formed with the first semisphere 21 to have a certain vertical angle a with respect to the opening plane of the first semisphere 21. The handrail holder 31 can be attached to this fitting portion 23 by a nut 37 substantially shaped a frustum of circular cone. By means of a washer not shown, the handrail holder 31 can slightly move by imposing certain force. The tilting angle α between the opening plane of the first semisphere 21 and the fitting portion 23 is approximately 22 degrees with respect to the opening plane. The tilting angle a is not limited to these degrees but can be adjusted as one likes. Preferably, as shown later, it should be in the range from 5 degrees to 25 degrees by taking the slope where the handrails are to be installed into consideration.

Furthermore, at the top section of the first semisphere 21, the attaching hole 21a is provided to put a bolt 41 therethrough.

On the other hand, at the second semisphere 22 that forms the elbow body 20, as shown in FIG. 5, the bolt shaped fitting portion 23 having male-screw screw therearound is provided likewise to attach the handrail holder 32. The fitting portion 24, as shown in FIGS. 2 and 3, is provided with the second semisphere 22 to have a certain vertical angle α′ with respect to the opening plane of the second semisphere 22. The handrail holder 32 is attached to this fitting portion 24 by a nut 38 substantially shaped a frustum of circular cone. Like the fitting portion 23, the tilting angle α′ between the opening plane of the second semisphere 22 and the fitting portion 24 is approximately 22 degrees with respect to the opening plane. The fitting portion 23 and the fitting portion 24 are symmetrically locating on the same line L1. Like the fitting portion 23, the tilting angle α′ of the fitting portion 24 of the handrail holder 32 is not limited to this angle but can be adjusted as one likes. Preferably, it should be in the range from 5 degrees to 25 degrees.

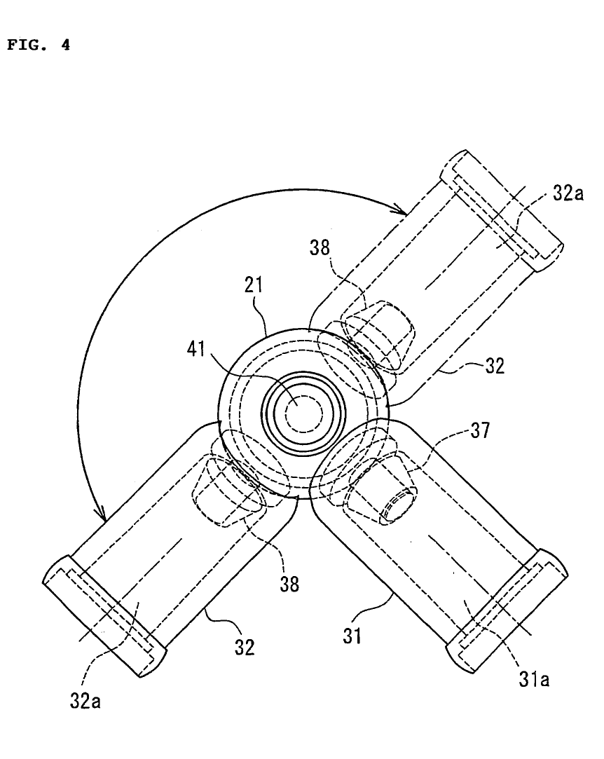

At the top section of the second semisphere 22, the attaching hole 22a is provided to insert the tip of the post connector 10. The first semisphere 21 and the second semisphere 22 are combined with each other on their openings to form the approximately spherical shaped elbow body 20 and the first semisphere 21 and the second semisphere 22 are rotatable relatively to each other on the same axis as shown in FIG. 4. By means of a washer not shown, the first semisphere 21 and the second semisphere 22 can slightly move by imposing certain force.

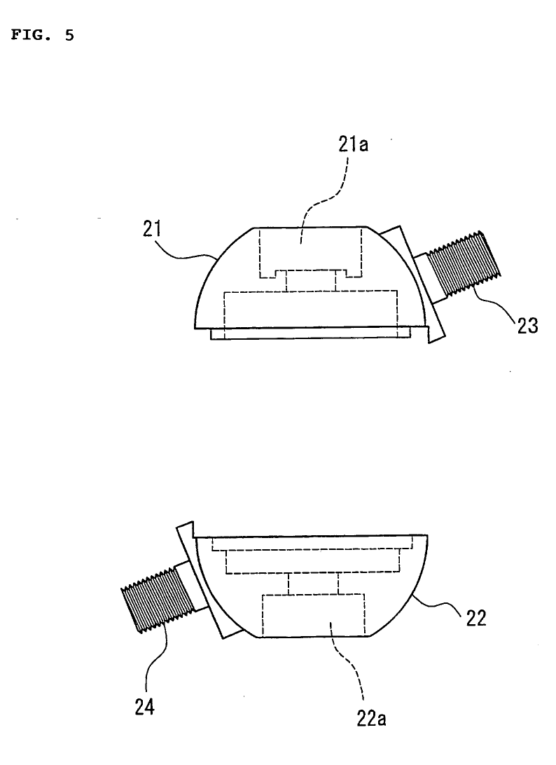

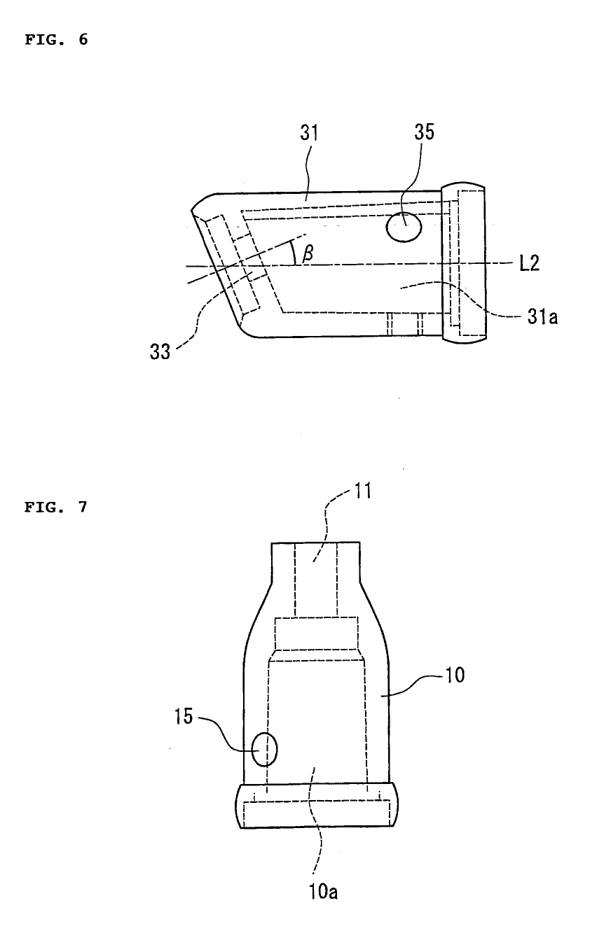

The handrail holder 31 attached to the first semisphere 21 has, as shown in FIG. 6, an approximately circular cylindrical shape. It includes the handrail holding portion 31a that holds the inserted handrail member 7 and the screw hole 35 to put through a securing screw not shown to secure the inserted handrail member 7 inside. Furthermore, on the opposite side of the handrail holding portion 31a of handrail holder 31 to which the handrail member 7 is inserted, the insert hole 33 is provided to receive the fitting portion 23 and has an tilting angle β with respect to the center line L2 that goes through the center of the cylinder of the handrail holder 31. The handrail holder 31 is held to the elbow body by the nut 37 substantially shaped a frustum of circular cone inside the handrail holding portion 31a while maintaining the fitting portion 23 inside the insert hole 33 so that the handrail holder 31 is rotatably attached to the fitting portion 23. When the handrail holder 31 rotates, because the handrail holding portion 31a tilts by the tilting angle β, the handrail holding portion 31a rotates with its tip moving circularly or moves in a neck roll exercise manner along with the rotation. Because of this structure, the handrail holding portion 31a can continuously move from-β(as shown in FIG. 2) to +β(as shown in FIG. 3) with respect to the fitting portion 23 so that the handrail member 7 can be secured at the intended angle within that range.

The tilting angle β of the insert hole 33 in the present embodiment is, like the tilting angle α of the fitting portion 23 with respect to the first semisphere 21, about 22 degrees. By setting the tilting angle β of the insert hole 33 and the tilting angle α of the fitting portion 23 to be identical, when the handrail jointer 1 is attached to the post 5 standing plumb-bob vertically on the slope 3, the handrail members 7 can be installed horizontally. Specifically, for the present embodiment, the handrail members can be installed in the range from α-β(22 degrees−22 degrees=0 degree, horizontal) to α+β(22 degrees+22 degrees=44 degrees). The tilting angle of the insert hole 33 is not limited to this angle but could be set as one likes. By taking the angle of gradient of the actual slope into considerations, the range is preferably set between 5 degrees and 25 degrees so that the handrail member 7 can be installed with the connecting angle ranging from horizontal (0 degree) to 50 degrees. Therefore, if the tilting angle of the insert hole 33 is set to be ranging from 5 degrees to 25 degrees, the practically required range can be sufficed.

On the other hand, because the handrail holder 32 attached to the second semisphere 22 has an approximately circular cylindrical shape like the above-mentioned handrail holder 31, its structure and its relations with the handrail holder 32 is the same as those of the handrail holder 31 so that detailed explanation is omitted here. Yet, because the handrail holding portion 32a is tilted at the angle β′ with respect to the fitting portion 24, when the handrail holding portion 32a rotates, the handrail holding portion 32a rotates in a neck roll exercise manner around the center axis.

The tilting angle of the fitting portions 23, 24 with respect to the first semisphere 21 and the second semisphere 22 is not limited to the angle described above, but could be made horizontal.

Furthermore, the fitting portions 23, 24 do not have to be formed at a slant but can be formed radially and in parallel to the opening planes of the first semisphere 21 and the second semisphere 22. In this situation too, because the handrail holders 31, 32 are rotatable on the fitting portions 23, 24 as their centers, it is possible to form the handrail member 7 aslant to the post 5. In this case, the range of the possible tilting angle of the handrail holders 31, 32 solely depends on the tilting angle of the insert holes 33, 34 so that the range of the total tilting angle will be less than when the fitting portions 23, 24 are formed aslant.

The post connector 10 has, as shown in FIG. 7, an approximate circular cylindrical shape with its tip being narrowed, and its tip is inserted into the attaching hole 22a provided on the second semisphere 22. The upper surface of the upper portion of the post connector 10 is provided with the insert hole 11 through which the bolt 41 that vertically penetrates the elbow body 20 consisting of the first semisphere 21 and the second semisphere 22 is inserted. The lower portion of the post connector 10 is provided with the post connecting portion 10a having a space for holding the post 5. With a washer 45 being placed inside the post connecting portion 10a, the bolt 41 that penetrates inside the elbow body 20 is fastened by a nut 43 so that the post connector 10 is attached to the elbow body 20. In this way, the first semisphere 21 and the second semisphere 22 can rotate relative to each other around the bolt 41, and hence the fitting portions 23, 24 can rotate on the axis of the bolt 41, namely center line Z that penetrates the post connector 10. On the side surface of the post connector 10, a screw insert hole 15 is provided for a fastening screw not shown to be put through to secure the post 5 that is inserted into the post connecting portion 10a.

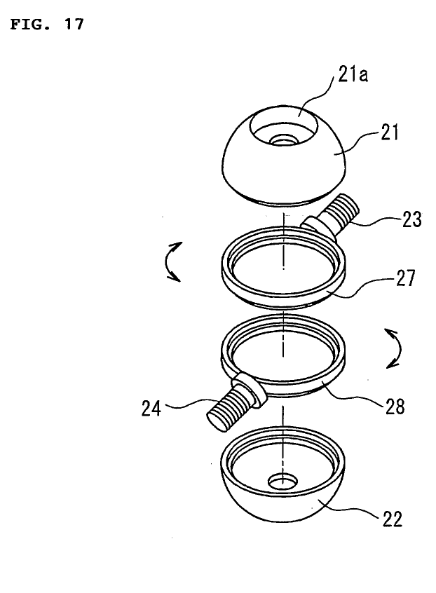

Other than the fitting portion 23 being directly formed on the first semisphere 21, as shown in FIG. 17, the ring member 27 is provided to rotate relative to the first semisphere 21 and, the fitting portion 23 can be formed aslant to this ring member 27. Likewise, on the second semisphere 22, a ring member 28 is provided and the fitting portion 24 is formed aslant thereto so that the ring member 27 and the ring member 28 rotate on the same axis and relative to each other, and in this way too, the elbow body 20 can be formed.

As shown in FIG. 16, for the posts 5a, 5b locating at the both ends, the handrail jointers 1a, 1b can have only one of the fitting portions 23, 24 and one of the handrail holders 31, 32. In other words, the handrail jointer 1a, which is attached to the post 5a locating at the bottom place, has no structure corresponding to the fitting portion 24 on the second semisphere 22 and the handrail holder 32 is not attached. The handrail jointer 1b, which is attached to the post 5b locating at the topmost place, has no structure corresponding to the fitting portion 23 on the first hemisphere 21 and the handrail holder 31 is not attached.

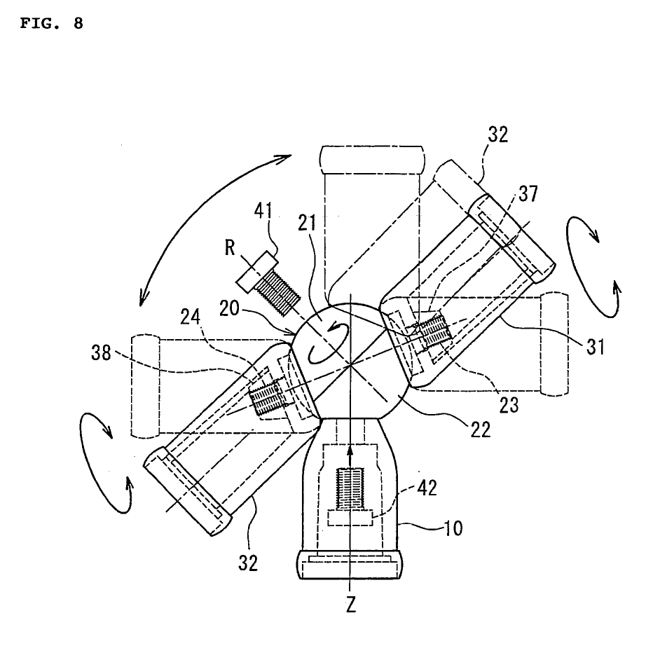

At the handrail jointer 1 shown in FIG. 8, the elbow body 20 is formed in such a manner that the axis of rotation R of the first semisphere 21 and the second semisphere 22 combined with each other is aslant to the center axis Z of the post connector 10. In this case, the bottom section of the second semisphere 22 that has the shape wherein the opening plane is cut aslant is attached to the post connecter 10 by means of the bolt 42. The elbow body 20 is formed in such a manner that the opening plane of the second semisphere 22 and the opening plane of the first semisphere 21 are combined to rotate by means of the bolt 41 penetrating from the direction of the axis of rotation R. The elbow body 20 can be made rotatable by press fitting the opening plane of the second semisphere 22 and that of the first semisphere 21. Because the rotational plane is aslant, the handrail holder 32 attached to the first semisphere 21 can move in a wider range than the handrail holder 32 attached to the handrail jointer 1 shown in FIG. 1. Furthermore, the second semisphere 22 can be either secured to the post connector 10 or attached to the post connector 10 in such a manner that the second semisphere can rotate horizontally.

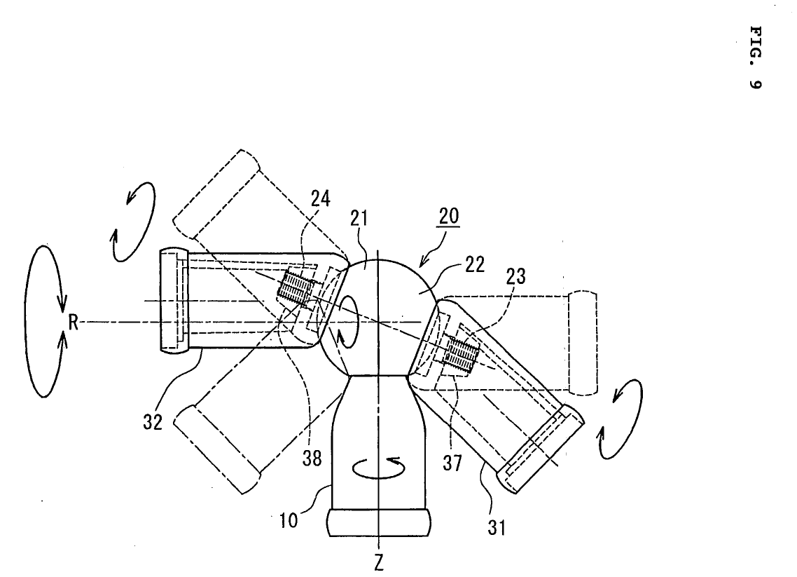

In the handrail holder 1 shown in FIG. 9, the elbow body 20 is formed in such a manner that the first semisphere 21 is press fitted to the semisphere 22 that is secured to the post connector 10 whereby the first semisphere 21 can rotate around the axis of rotation R perpendicular to the center axis Z of the post connector 10. In other words, while the protrusion is provided to protrude outward from the outer rim of the first semisphere 21, the second semisphere 22 has the catching part that fits with the protrusion. The protrusion of the first semisphere 21 is inserted into the catching part of the second semisphere 22 to form the press-fitting structure not shown so that the first semisphere 21 can rotate. Because of this structure, as shown, the fitting portion 24 rotates in a neck roll exercise manner by the rotation of the first semisphere 21. Due to this additional neck roll rotation, the range of movement for the handrail holder 32 is wider than that of the handrail holder 31.

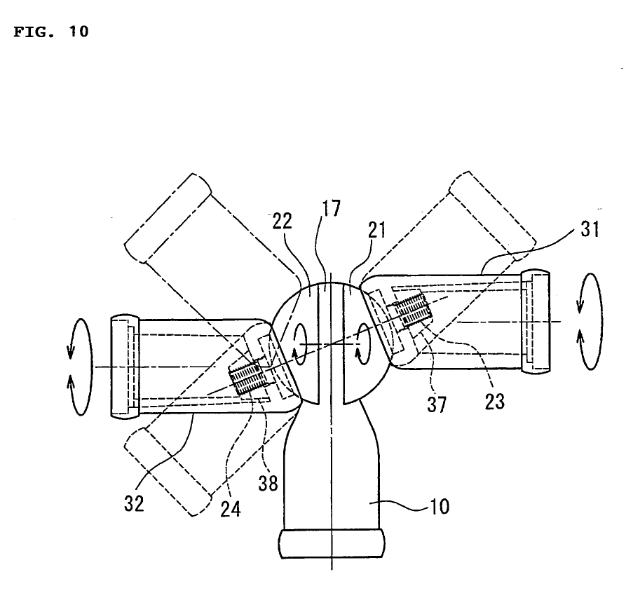

In the handrail holder 1 shown in FIG. 10, the first semisphere 21 and the second semisphere 22 are rotatably attached to the connecting section 17 provided on the post connector 10. The opening planes of the first semisphere and the second semisphere are abutted on the both sides of the connecting section 17. The protruding connecting parts that protrude from the both sides of the connecting section 17 are press fitted to the catching parts provided in each of the interior of the first semisphere 21 and the second semisphere 22 to form the press-fitting structure not shown. Because of this structure, each of the first semisphere 21 and the second semisphere 22 can rotate. The one shown in FIG. 11 is the type where the connecting section 17 is formed aslant to the post connector 10.

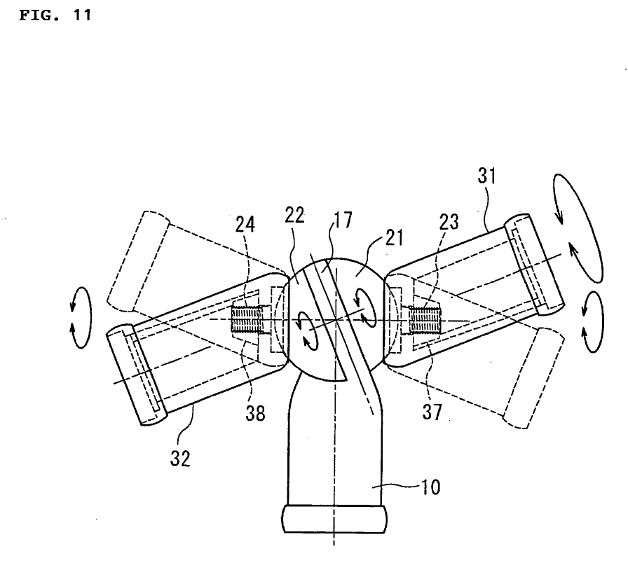

The method of attaching the handrail members 7 to the handrail holding portions 31a, 32a of the handrail holder 31, 32 is not limited to any extent and could be like the ones shown in FIGS. 12˜15. FIG. 12 shows the method in which adhesive 7a is plastered on the surface of the handrail member 7 and inserted into and secured to the inside of the handrail holding portion 31a. This is effective when the handrail member 7 is made of resin, wood or light metal. FIG. 13 shows the method in which the edge of the handrail holding portion 31a is put in a very close contact with and welded to the surface of the handrail member 7.

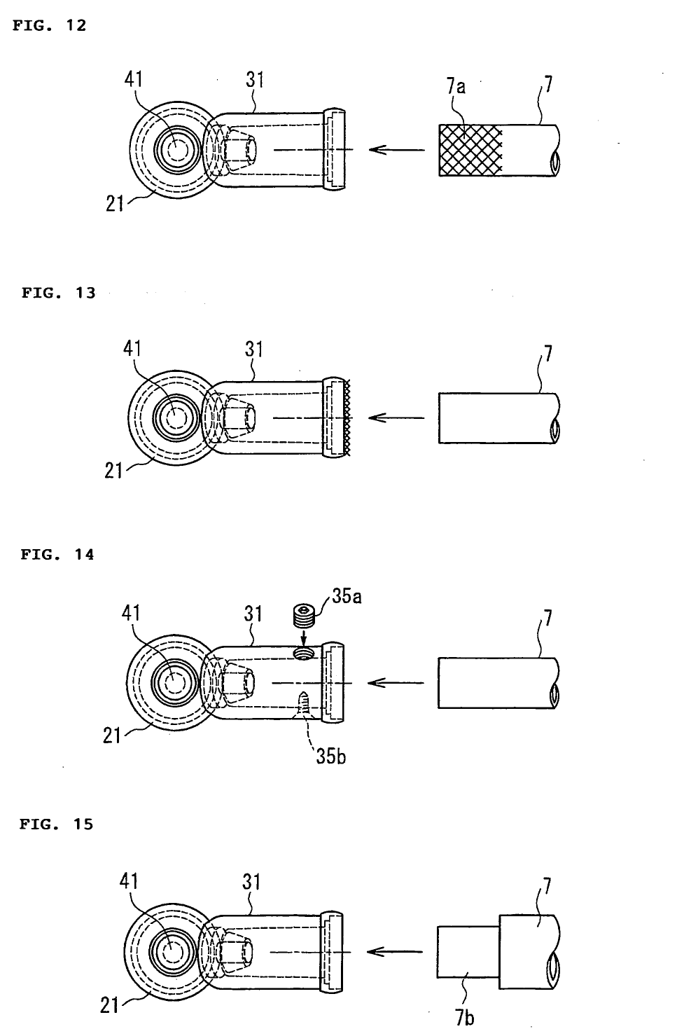

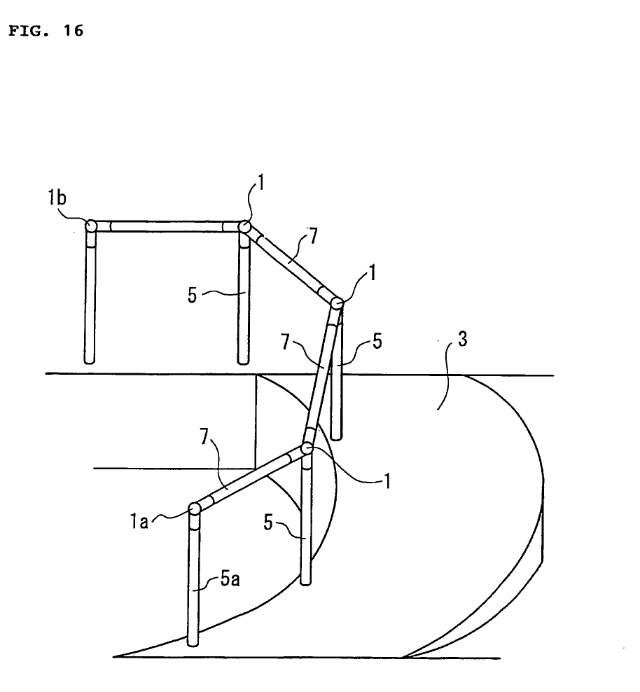

FIG. 14 shows the method in which the handrail member 7 that is inserted into the handrail holding portion 31a is secured by means of a fastening screw 35a fitted to the screw hole 35 and also that the handrail member 7 is secured by means of a screw 35b. FIG. 14 is to show just examples on how to fasten and it does not mean to say that both the fastening screw 35a and the screw 35b must be used. FIG. 15 shows the method in which the tip of the handrail member 7 is provided with a support portion 7b and, after inserting the support portion 7b into the inside of the handrail support portion 31a, it is secured by the methods shown in FIG. 12 or FIG. 13. Furthermore, it is possible to make the handrail holders 31, 32 themselves to be the handrail members 7.

Next, the method of installing the handrail jointers 1 of the present invention is explained. The slope 3 where the handrails are to be installed shown in FIG. 16 has a complicated shape such that it is bent and inclined upward and that its angle of gradient varies along the way. Near the edge of the slope 3, the posts 5, 5a, 5b are installed plumb-bob vertically in designated locations.

Then, the post 5a is positioned in such a manner that the tip of the post 5a can be inserted into the post connecting portion 10a of the post connector 10 of the handrail jointer 1a and secured by means of a screw not shown fitted to the hole 15. One end of the handrail member 7 whose length is adjusted according to the intervals between the installation locations of the posts 5, 5a, 5b is inserted to the handrail holding portion 31a of the handrail jointer 1a and is secured with a screw not shown fitted to the screw hole 35. The opposite end of the handrail member 7 is inserted to the handrail holder 32a of another handrail jointer 1, and then the tip of the second post 5 from the bottom place is inserted to the post connecting portion 10a. By rotating around the fitting portion 24 the handrail holder 32 of the handrail jointer 1, which is attached to the second post 5 from the bottom place, the handrail member 7 is adjusted to the desired angle of gradient. At the same time, by rotating the handrail holder 31 of the handrail jointer la around the fitting portion 23 as well as by rotating the first semisphere 21 in relation to the second semisphere 22, the angle of gradient of the handrail member 7 is adjusted. Then, upon the appropriate angle of gradient being decided, the handrail member 7 and the handrail holder 32 are firmly secured by means of a screw not shown fitted to the screw hole 36 of the handrail holder 32 of the handrail jointer 1 attached to the second post 5 from the bottom place. The post connector 10 and the post 5 are also firmly secured by means of a screw not shown fitted to the screw hole 15 of the post connector 10.

Next, the tip of another handrail member 7 is inserted into the handrail holding portion 31a of the handrail holder 31 of the second handrail jointer 1 from the bottom place and the handrail holder 31 and the handrail member 7 are firmly secured with a screw not shown fitted to the screw hole 35. The opposite end of this handrail member 7 is then inserted to a handrail holding portion 32a of another handrail jointer 1 and the tip of the third post 5 from the bottom place is inserted to the handrail holding portion 10a thereof. Then, by rotating the handrail holder 32 of the third handrail jointer 1 from the bottom place around the fitting portion 24, the handrail member 7 is adjusted to the desired angle of gradient. At this time, by rotating the handrail holder 31 of the second handrail jointer 1 from the bottom place around the fitting portion and by rotating the first semisphere 21 relative to the second semisphere 22, the angle of gradient of the handrail member 7 is adjusted. Then, once the appropriate angle of gradient is decided, the handrail member 7 and the handrail holder 32 are firmly secured by means of a screw not shown fitted to the screw hole 36 of the handrail holder 32 of the handrail jointer 1 attached to the third post 5 from the bottom place, the post connector 10 and the post 5 are secured by means of a screw not shown fitted to the screw hole 15 of the post connector 10.

By repeating the above-mentioned procedure, the handrails can be installed easily on the bent slope 3 with a varying incline.

### Industrial Applicability

The handrail jointer of the present invention is comprised of a post connector that connects with the post, handrail holders that have handrail holding portions to hold handrail members and an elbow body that connects the post connector and has the fitting portions to attach the handrail holders, being characterized in that the handrail holders are rotatably attached to the fitting portions with certain angles, whereby the handrail holders can rotate in a neck roll exercise manner around the fitting portion. Due to this structure, the handrails can be installed at the site easily on the slope which is bent and has a complicated shape having a varying inclination. Therefore, it becomes unnecessary to prepare different types of handrail material depending on the angle of gradient of the placing site, so that the handrail jointer of the present invention has high workability and lowers the cost of installment in comparison with the techniques used for conventional models.

1. A hand jointer comprising
a post connector that connects with a post,
handrail holders that have handrail holing portions to hold handrail members, and an elbow body that connects to said post connector and has fitting portions to attach said handrail holders,
being characterized in that said handrail holders are rotatably attached to said fitting portions with certain angles with respect to the center axis that goes through the center of said handrail holder and the tips of said handrail holders move circularly along with the rotation of said handrail holders around said fitting portions so that said handrail holders can rotate in a neck roll exercise manner around said fitting portions.

2. A handrail jointer as defined in claim 1
being characterized in that said fitting portions of said handrail jointers are formed aslant to said elbow body.

3. The handrail jointer defined in claim 1 being characterized in that said elbow body of said handrail jointer is rotatably attached to said post connector.

4. The handrail jointer defined in claim 1 being characterized in that, while said elbow body has an approximate spherical shape by consisting of a first semisphere and a second semisphere, the opening planes of which are put together, being provided with said fitting portions in diagonally opposite locations on the surface thereof, said first semisphere and said second semisphere can relatively rotate on the same axis.

5. The handrail jointer defined in claim 4 being characterized in that said fitting portions are formed aslant to said elbow body and directed at certain tilting angles in a vertical plane with respect to said opening planes of said first semisphere and said second semisphere.

6. The handrail jointer defined in claim 5 being characterized in that said tilting angle of the fitting portion is from 5 degrees to 25 degrees.

7. The handrail jointer defined in claim 4 being characterized in that the axis of rotation of said first semisphere and said second semisphere of the handrail jointer is perpendicular or aslant to the center axis of said post connector.

8. The handrail jointer defined in claim 6 being characterized in that said first semisphere and said second semisphere are relatively rotatably attached to a connecting section formed on said post connector.

9. The handrail jointer defined in claim 6 being characterized in that said tilting angle of said fitting portions formed on said elbow body is the same as the attaching angle of said handrail holder with respect to said fitting portions.
